(19) United States
(12) Patent Application Publication
(10) Pub. No.: US 2008/0056299 A1
(43) Pub. Date: Mar. 6, 2008

(54) Apparatus and method of providing data broadcasting service of filtering out data broadcasting services that include applications from a plurality of stored data broadcasting services

(75) Inventor: Kwang-hyuk Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/650,538

(22) Filed: Jan. 8, 2007

(30) Foreign Application Priority Data
Sep. 6, 2006 (KR) 10-2006-0085892

(51) Int. Cl. H04J 3/22

(52) U.S. Cl. 370/465; 370/390

(57) ABSTRACT

An apparatus and method of providing a data broadcasting service, the apparatus and method capable of filtering out data broadcasting services that include applications in addition to media data from a plurality of recorded data broadcasting services. The apparatus includes a recording filter generating a search list used to search stored data broadcasting services; and a recording manager controlling the recording filter to generate the search list of data broadcasting services that include applications related to the data broadcasting services, the data broadcasting services being filtered out from the stored data broadcasting services. The apparatus can filter out data broadcasting services that include applications from a plurality of stored data broadcasting services and provide a search list of the filtered-out data broadcasting services.

### BACKGROUND OF THE INVENTION

This application claims the priority of Korean Patent Application No. 10-2006-0085892, filed on Sep. 6, 2006, in the Korean Intellectual Property Office, the disclosure of which is incorporated herein in its entirety by reference.

1. Field of the Invention

The present invention relates to an apparatus and method of providing a data broadcasting service, and more particularly, to an apparatus and method of providing a data broadcasting service of filtering out data broadcasting services that include applications in addition to media data from a plurality of recorded data broadcasting services.

2. Description of the Related Art

Data broadcasting is a service of providing various information related to a broadcasting program, living information, Internet connection, electronic commerce, and interactive entertainment using a broadcasting network, such as a terrestrial, satellite or cable network, in addition to providing the broadcasting program. Conventional international data broadcasting standards include an open cable application platform (OCAP), an advanced common application platform (ACAP), and a multimedia home platform (MHP).

In the case of OCAP/MHP/ACAP, an application is included in a data broadcasting service and provided accordingly. Therefore, when recording a data broadcasting service, an apparatus for storing a data broadcasting service, such as a digital video recorder (DVR), records an application included in the data broadcasting service, together with media data such as audio and/or video data. However, when a conventional recording list, which is a search list of data broadcasting services, is generated, data broadcasting services which include both the media data and applications are not distinguished from data broadcasting services which include media data but do not include applications. Hence, a user cannot separately search and use these different types of data broadcasting services.

### SUMMARY OF THE INVENTION

The present invention relates to an apparatus and method of providing a data broadcasting service of filtering out data broadcasting services that include relevant applications from a plurality of recorded data broadcasting services.

The present invention also relates to an apparatus and method of providing a data broadcasting service of providing a search list of filtered-out data broadcasting services that include relevant applications.

The present invention also relates to an apparatus and method of providing a data broadcasting service of controlling the operation of an application when executing a data broadcasting service that includes the application.

According to an aspect of the present invention, there is provided an apparatus for providing a data broadcasting service. The apparatus includes a recording filter generating a search list used to search stored data broadcasting services; and a recording manager controlling the recording filter to generate the search list of data broadcasting services that include applications related to the data broadcasting services, the data broadcasting services being filtered out from the stored data broadcasting services.

The apparatus may further include a data broadcasting reception unit receiving a data broadcasting signal and generating a data broadcasting service; and an application manager processing application-related information included in the data broadcasting signal.

The application-related information may include information indicating whether an application related to the data broadcasting service has to be stored.

The application-related information may further include at least one of identification information for identifying the application, information indicating an operation mode of the application, position information of the application, information regarding the name of the application, and priority information of the application.

The recording manager may set information indicating whether an application related to a data broadcasting service has been stored when controlling the storing of the data broadcasting service.

The recording manager may control the recording filter to generate the search list based on a search condition which is used to search for some of the stored data broadcasting services.

The search condition may include at least one of an operation mode of the application, the name of the application, a priority of the application, and state information indicating a state in which the application related to the data broadcasting service was stored.

The operation mode of the application may be an auto start mode in which the application related to the data broadcasting service is automatically executed when the data broadcasting service is executed or a manual start mode in which an additional input is required to execute the application.

The operation mode may be changed by a user input signal.

The recording manager may store the state information indicating the state in which the application related to the broadcasting service was stored.

The application manager may form a screen for providing information regarding a data broadcasting service in order to provide at least one of the application-related information and the state information indicating the state in which the application related to the data broadcasting service was stored.

The apparatus may further include an output unit outputting the search list of the filtered-out data broadcasting services.

According to another aspect of the present invention, there is provided a method of providing a data broadcasting service. The method includes filtering out data broadcasting services that include applications related to the data broadcasting services from a plurality of stored data broadcasting services; and generating a search list of the filtered-out data broadcasting services and providing the search list.

According to another aspect of the present invention, there is provided a method of storing a data broadcasting service. The method includes setting information indicating whether an application related to a data broadcasting service has been stored; and storing state information indicating a state in which the application related to the broadcasting service was stored.

According to another aspect of the present invention, there is provided a computer-readable recording medium on which a program for executing a method of providing a data broadcasting service is recorded, the method including filtering out data broadcasting services that include applications related to the data broadcasting services from a plurality of stored data broadcasting services; and generating a search list of the filtered-out data broadcasting services and providing the search list.

According to another aspect of the present invention, there is provided a computer-readable recording medium on which a program for executing a method of storing a data broadcasting service is recorded, the method including setting information indicating whether an application related to a data broadcasting service has been stored; and storing state information indicating a state in which the application related to the broadcasting service was stored.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for providing a data broadcasting service of filtering out data broadcasting services that include applications from a plurality of stored data broadcasting services, according to an exemplary embodiment of the present invention;

FIG. 2 is a flowchart illustrating a method of storing a data broadcasting service according to an exemplary embodiment of the present invention;

FIG. 3 is a flowchart illustrating a method of filtering out data broadcasting services that include applications from a plurality of stored data broadcasting services according to an exemplary embodiment of the present invention; and

FIG. 4 is a flowchart illustrating a method of filtering out data broadcasting services that include applications from a plurality of stored data broadcasting services according to another exemplary embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

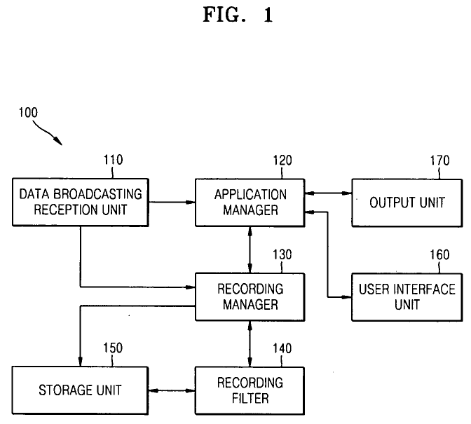

FIG. 1 is a block diagram of an apparatus 100 for providing a data broadcasting service of filtering out data broadcasting services that include applications from a plurality of stored data broadcasting services, according to an exemplary embodiment of the present invention. Referring to FIG. 1, the apparatus 100 includes a data broadcasting reception unit 110, an application manager 120, a recording manager 130, a recording filter 140, a storage unit 150, a user interface unit 160, and an output unit 170.

The data broadcasting reception unit 110 receives a data broadcast through a broadcasting network, such as a terrestrial, satellite or cable network, and generates a discrete broadcasting service. In the present specification, a broadcasting service may include a broadcasting program composed of audio and/or video data and a broadcasting program including media data, such as audio and/or video data, and an application related to the data broadcasting service, which can be executed together with the media data.

The application manager 120 processes what is written in “Application Model” and “Application Signalling” of chapters 10 and 11, respectively, of OC-SP-OCSP1.0-I16-050803. In other words, the application manager 120 processes application-related information received from the data broadcasting reception unit 110. The application-related information includes an application information table (AIT) and/or an eXtended application information table (XAIT). The application manager 120 loads and executes an application and manages a life cycle of the application using signalling of the application, which includes information regarding the AIT or the XAIT.

Here, applications are classified into a bound application which is bound or related to a particular broadcasting service and an unbound application which is not bound to a particular broadcasting service. The unbound application, such as a digital video recorder (DVR) application, performs a management operation in order to provide a data broadcasting service. For example, the unbound application provides an electronic program guide (EPG) so that a user can manage the recording of a data broadcasting service or provides a search tool so that the user can search for a desired data broadcasting service.

The AIT provides information regarding an activation state of a bound application. The AIT includes information regarding whether an application related to a data broadcasting service has to be stored. In addition, the AIT includes information regarding basic attributes of an application.

The information regarding basic attributes of an application includes at least one of an application identification (ID), which is identification information for identifying an application, a control code indicating an auto start or a manual start, a priority of the application, position information of the application, and the name of the application. The XAIT is a table for launching and managing an unbound application.

The recording manager 130 is controlled by the application executed by the application manager 120. In addition, the recording manager 130 controls the storing of a reserved broadcasting service by designating a schedule based on a user input signal of the user interface unit 150.

The storage unit 150 stores a data broadcasting service, which is delivered through a data broadcasting signal, under the control of the recording manager 130. In other words, the storage unit 150 stores media data included in a data broadcasting service and an application which runs in relation to the data broadcasting service. In addition, the storage unit 150 stores application-related information, media data, and general information regarding a data broadcasting service, such as timing information required for an application to run. A separate database for managing information stored in the storage unit 150 may be implemented in the storage unit 150.

The recording manager 130 sets in the storage unit 150 information indicating whether an application related to a data broadcasting service has been stored in the storage unit 150 together with the data broadcasting service. The information indicating whether the application related to the data broadcasting service has been stored in the storage unit 150 together with the data broadcasting service may be stored in a predetermined field created in the database for managing information stored in the storage unit 150.

The recording filter 140 generates a search list used to search a plurality of data broadcasting services stored in the storage unit 150. Under the control of the recording manager 130, the recording filter 140 searches the storage unit 150, filters out data broadcasting services having relevant applications from the data broadcasting services stored in the storage unit 150, and generates a search list of the filtered-out data broadcasting services. In other words, the search list includes a list of data broadcasting services, which include media data and applications related to the data broadcasting services, from among the data broadcasting services stored in the storage unit 150.

The recording filter 140 may interpret the predetermined field which is created in the database that manages data stored in the storage unit 150 and in which the information indicating whether an application related to a data broadcasting service has been stored in the storage unit 150 together with the data broadcasting service is set, and generate a search list. In addition, the recording filter 140 may also generate a search list using various other methods.

Referring to FIG. 1, the recording manager 130 instructs the recording filter 140 to filter out data broadcasting services having relevant applications. However, this filtering operation may be performed by a separate functional unit, which may be called an application filter (not shown).

Since the information indicating whether an application related to a data broadcasting service has been stored in the storage unit 150 together with the data broadcasting service is set in the storage unit 150, the recording filter 140 may filter out data broadcasting services having relevant applications and generate a search list of the filtered-out data broadcasting services.

The user interface unit 160 receives a user input signal and controls an application for providing a data broadcasting service, such as a DVR application, to provide a data broadcasting service according to the user input signal.

The output unit 170 includes a display device and an audio signal processing and outputting device. Therefore, the output unit 170 processes a data broadcasting service into a video or audio signal and outputs the video or audio signal. In addition, the output unit 170 outputs EPG information provided by the application manager 120. The output unit 170 also outputs a search list of data broadcasting services filtered out according to the exemplary embodiment of the present invention.

According to an exemplary embodiment of the present invention, the recording manager 130 stores in the storage unit 150 state information indicating whether an application related to a data broadcasting service has been normally stored in the storage unit 150. A predetermined r field for storing the state information is created in the storage unit 150 and may be used for search. States in which an application related to a data broadcasting service is stored may be classified into five states—that is, a complete state, an incomplete state, a failed state, an in-progress state, and an exception state—and stored accordingly.

The complete state indicates that an application was completely stored, and the incomplete state indicates that the storing of an application was stopped after the application had been partially stored. The failed state indicates that the storing of an application has failed and thus the application was not stored, and the in-progress state indicates that the storing of an application is in progress. In addition, the exception state indicates that an application was stored but has a problem such as an error.

Since the states in which an application was stored are stored in the storage unit 150 and the state information is provided to a user, the user can identity a state in which an application related to a data broadcasting service selected by the user was stored and identify whether the application can be executed. If the selected data broadcasting service was not stored normally and thus cannot be executed, a message informing the user that the application cannot be executed may be provided to the user. This operation may be performed in such a way that the application manager 120 forms a screen for providing the above information and the output unit 170 outputs the information.

According to another exemplary embodiment of the present invention, the recording manager 130 may control the recording filter 140 to generate a search list based on a search condition which is set based on the user input signal. The search condition may include the operation mode, name, priority and state information of an application.

The operation mode of an application denotes an operation mode according to the control code described above. The operation mode of an application includes an auto start mode in which an application related to a data broadcasting service is automatically executed when the data broadcasting service is executed, a manual start mode in which an additional input is required to execute an application related to a data broadcasting service, and a remote mode indicating that a data broadcasting service is received through a different channel.

The operation mode may be changed by a user. For example, on a screen for providing information regarding a data broadcasting service, the user may change the auto start mode to the manual start mode through the user interface unit 160 so that only media data included in a data broadcasting service can be executed before the user executes an application. Alternatively, the user may change the manual start mode to the auto start mode so that an application related to a data broadcasting service can be automatically executed when the user selects and executes the data broadcasting service. If the user is allowed to change information regarding application execution as well as the operation mode, the user may control application execution, such as an application execution order.

The application manager 120 may include and form either application-related information or state information, or both the application-related information and the state information in a screen for providing information regarding an application related to a data broadcasting service. Therefore, a user may obtain a search list of desired data broadcasting services by setting a search condition using the above information.

In this exemplary embodiment, the storage unit 150 is included in the apparatus 100. However, the apparatus 100 may not include a storage device such as the storage unit 150. In this case, the apparatus 100 may store a data broadcasting service in an external storage device, which is connected to the apparatus 100 and can transmit or receive data to/from the apparatus 100. In addition, the apparatus 100 may perform operations according to exemplary embodiments of the present invention using the external storage device.

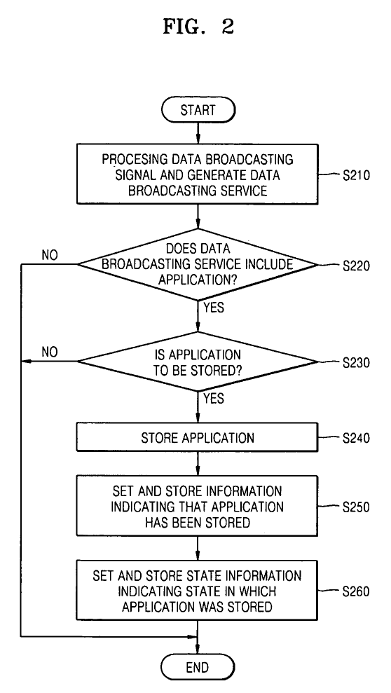

FIG. 2 is a flowchart illustrating a method of storing a data broadcasting service according to an exemplary embodiment of the present invention.

In operation S210, a data broadcasting signal is received and processed, and a data broadcasting service is generated.

In operation 220, it is determined whether the data broadcasting service generated after the data broadcasting signal is processed includes an application related to the data broadcasting service. In operation S230, it is determined whether to store the application. The determination may be made in operation S230 after application-related information that is received is interpreted and information indicating whether the application has to be stored is identified.

If it is determined that the application has to be stored, the application is stored in operation S240. As the data broadcasting service is processed, media data and the application-related information are also stored.

In operation S250, information indicating that the application related to the data broadcasting service has been stored is set and stored. Furthermore, if the application related to the data broadcasting service is absent or has not been stored, information indicating that the application is absent or has not been stored is set and stored.

In operation S260, the state information indicating a state in which the application was stored is set and stored. As described above, the state information may be classified into the complete state, the incomplete state, the failed state, the in-progress state and the exception state, and be stored accordingly.

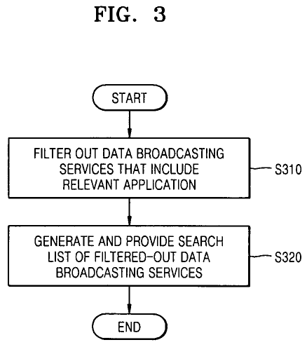

FIG. 3 is a flowchart illustrating a method of filtering out data broadcasting services that include applications from a plurality of stored data broadcasting services according to an exemplary embodiment of the present invention.

Referring to FIG. 3, in operation S310, data broadcasting services that include relevant applications are filtered out from a plurality of data broadcasting services stored. The data broadcasting services that include the relevant applications may be identified based on the information set in operation S250 of FIG. 2.

If all the data broadcasting services that include the relevant applications are filtered out, a search list of the filtered-out data broadcasting services is generated and provided in operation S320.

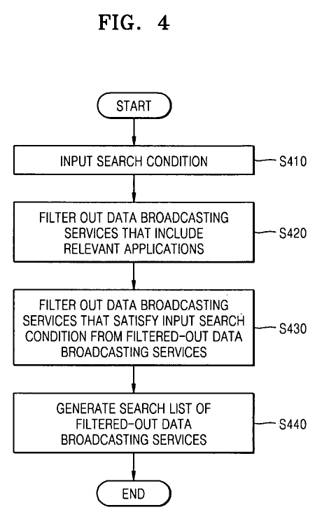

FIG. 4 is a flowchart illustrating a method of filtering out data broadcasting services that include applications from a plurality of stored data broadcasting services according to another embodiment of the present invention.

Referring to FIG. 4, a search condition based on a user input signal is input. The search condition includes at least one of the operation mode, name and priority of an application. The search condition may include the state information set in operation S260 of FIG. 2. Search conditions may be sequentially input or all input at the same time.

In operation S420, data broadcasting services that include relevant applications are filtered out from a plurality of stored data broadcasting services.

In operation S430, data broadcasting services that satisfy the input search condition are filtered out again from the filtered-out data broadcasting services. For example, if the search condition is the auto start mode, data broadcasting services which include relevant applications and are automatically executed as the data broadcasting services are executed would be filtered out.

In operation S440, a search list of the secondarily filtered-out data broadcasting services is generated and provided.

The present invention can also be implemented as computer-readable code on a computer-readable recording medium. Also, code and code segments for accomplishing the present invention can be easily construed by programmers skilled in the art to which the present invention pertains.

The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

As described above, an apparatus and method of providing a data broadcasting service according to the present invention can filter out data broadcasting services that include relevant applications from a plurality of recorded data broadcasting services and provide a search list of the filtered-out data broadcasting services.

The apparatus and method can provide a user with application-related information and state information regarding a state in which an application was stored.

In addition, the apparatus and method can filter out data broadcasting services that include relevant applications and can control the operation of an application when executing a data broadcasting service selected by a user.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for providing a data broadcasting service, the apparatus comprising:
a recording filter which generates a search list used to search stored data broadcasting services; and
a recording manager which controls the recording filter to generate the search list to include data broadcasting services that include applications related to the data broadcasting services, the data broadcasting services being filtered out from the stored data broadcasting services.

2. The apparatus of claim 1, further comprising:
a data broadcasting reception unit which receives a data broadcasting signal and generates the data broadcasting services; and
an application manager which processes application-related information included in the data broadcasting signal.

3. The apparatus of claim 2, wherein the application-related information comprises information indicating whether an application related to the data broadcasting service has to be stored.

4. The apparatus of claim 3, wherein the application-related information further comprises at least one of identification information for identifying the application, information indicating an operation mode of the application, position information of the application, information regarding the name of the application, and priority information of the application.

5. The apparatus of claim 1, wherein the recording manager sets information indicating whether the application related to the data broadcasting service has been stored when controlling the storing of the data broadcasting service.

6. The apparatus of claim 1, wherein the recording manager controls the recording filter to generate the search list based on a search condition which is used to search for some of the stored data broadcasting services.

7. The apparatus of claim 6, wherein the search condition comprises at least one of an operation mode of the application, the name of the application, a priority of the application, and state information indicating a state in which the application related to the data broadcasting service was stored.

8. The apparatus of claim 7, wherein the operation mode of the application is an auto start mode in which the application related to the data broadcasting service is automatically executed when the data broadcasting service is executed or a manual start mode in which an additional input is required to execute the application.

9. The apparatus of claim 8, wherein the operation mode may be changed by a user input signal.

10. The apparatus of claim 1, wherein the recording manager stores state information indicating the state in which the application related to the broadcasting service was stored.

11. The apparatus of claim 2, wherein the application manager forms a screen for providing information regarding at least one of the data broadcasting services in order to provide at least one of the application-related information and state information indicating the state in which the application related to the data broadcasting service was stored.

12. The apparatus of claim 1, further comprising an output unit which outputs the search list of the filtered-out data broadcasting services.

13. A method of providing a data broadcasting service, the method comprising:
filtering out data broadcasting services that include applications related to the data broadcasting services from a plurality of stored data broadcasting services; and
generating a search list of the filtered-out data broadcasting services and providing the search list.

14. The method of claim 13, further comprising:
determining whether an application related to the data broadcasting service is included in the data broadcasting service which is delivered through a data broadcasting signal;
determining whether to store the application; and
storing the application if it is determined to store the application.

15. The method of claim 14, wherein the determining of whether the application related to the data broadcasting service is included in the data broadcasting service comprises identifying information indicating whether the application related to the data broadcasting service has to be stored, the information being included in application-related information which is delivered through the data broadcasting signal.

16. The method of claim 13, further comprising setting information indicating whether the application related to the broadcasting service has been stored.

17. The method of claim 13, further comprising storing state information indicating a state in which the application related to the data broadcasting service was stored.

18. The method of claim 13, further comprising:
receiving a search condition used to search for some of the stored data broadcasting services; and
filtering out data broadcasting services that satisfy the received search condition.

19. The method of claim 18, wherein the search condition comprises at least one of an operation mode of the application, the name of the application, a priority of the application, and state information indicating a state in which the application related to the data broadcasting service was stored.

20. The method of claim 19, wherein the operation mode of the application is an auto start mode in which the application related to the data broadcasting service is automatically executed when the data broadcasting service is executed or a manual start mode in which an additional input is required to execute the application.

21. The method of claim 20, further comprising changing the operation mode of the application related to the data broadcasting service using a user input signal.

22. The method of claim 13, further comprising providing at least one of application-related information and state information indicating the state in which the application related to the data broadcasting service was stored on a screen for providing information regarding the stored data broadcasting service.

23. A method of storing a data broadcasting service, the method comprising:
setting information indicating whether an application related to a data broadcasting service has been stored; and
storing state information indicating a state in which the application related to the broadcasting service was stored.

24. The method of claim 23, further comprising:
identifying whether a data broadcasting service being received includes an application related to the data broadcasting service;
determining whether to store the application; and
storing the application based on the determination result.

25. A computer-readable recording medium on which a program for executing a method of providing a data broadcasting service is recorded, the method comprising:
filtering out data broadcasting services that include applications related to the data broadcasting services from a plurality of stored data broadcasting services; and
generating a search list of the filtered-out data broadcasting services and providing the search list.

26. A computer-readable recording medium on which a program for executing a method of storing a data broadcasting service is recorded, the method comprising:
setting information indicating whether an application related to a data broadcasting service has been stored; and
storing state information indicating a state in which the application related to the broadcasting service was stored.
